(19) United States
(12) Patent Application Publication
(10) Pub. No.: US 2023/0307922 A1
(43) Pub. Date: Sep. 28, 2023

(54) METHOD AND SYSTEM FOR MICROGRID CONTROL

(71) Applicant: TROES CORPORATION, Markham (CA)

(72) Inventors: Yiwen XIA, Markham (CA); Wei ZHOU, Markham (CA); Dennis DOS SANTOS, Markham (CA); Tongrui LI, Markham (CA)

(21) Appl. No.: 18/022,912

(22) PCT Filed: Aug. 24, 2021
(86) PCT No.: PCT/CA2021/051174

§ 371 Date: Feb. 23, 2023

Related U.S. Application Data
(60) Provisional application No. 63/069,353, filed on Aug. 24, 2020.

(51) Int. Cl. H02J 3/46; H02J 3/32; H02J 3/38

(52) U.S. Cl. CPC H02J 3/466; H02J 3/32; H02J 3/381; H02J 2300/24

(57) ABSTRACT

The disclosure is directed at a method and system for microgrid control. The system includes a controller that receives data from project site components and then controls the components based on the received data. The system monitors load demand and generates controls signals to control the power generating components to supply the necessary power to support load demand. The power generating components may include a battery, a solar/wind power generation device or a diesel generator.

### CROSS-REFERENCE TO RELATED APPLICATIONS

The current disclosure claims the benefit of priority from U.S. Provisional Application No. 63/069,353 filed Aug. 24, 2020 which is hereby incorporated by reference.

### FIELD

The disclosure is generally related to microgrid systems, and more specifically, the disclosure is directed at a method and system for microgrid control.

### BACKGROUND

In the past few decades, the scale of a power grid has continued to expand, and has gradually developed into a super large interconnected network system for centralized power generation and long-distance transmission. However, the continuous increase of long-distance transmission has resulted in some problems such as requiring the receiving power grid to be increasingly dependent on external power, declining stability and safety of power grid operation and difficulty in meeting the diverse power supply needs. Also, concerns about the gradual depletion of global conventional energy and environmental pollution have become increasingly prominent. In view of this, environmentally friendly, efficient and flexible distributed power generation is widely favored. Distributed power generation generally refers to a way of distributing relatively small power generation devices (generally below 50 MW) at the user/load site or nearby locations to achieve power generation and energy supply.

Distributed power generation has the characteristics of flexible location and decentralization, which is adapted to distributed power demand and resource distribution, delaying the huge investment required for the upgrade of the transmission and distribution network; backing up with the large power grid, and also improving the reliability of power supply. It also has the advantages of less pollution and higher energy efficiency. Despite its advantages, distributed power generation also has many problems: the cost of single-unit distributed power supply is high, and control is difficult; distributed power is an uncontrollable source relative to a large power grid, and large systems often take the form of restrictions and isolation. When the power system fails, distributed power sources often have to withdraw from operation as soon as possible, which greatly limits the full play of distributed power generation efficiency. In order to coordinate the contradiction between the large power grid and distributed power and to fully tap the value and benefits of distributed power to the power grid end users, microgrid controllers have been introduced. The microgrid (MG) controller controls distributed power generation, energy storage devices, and loads through the control system to form a single controllable unit, which is directly connected to the user side. As a complete power system, it relies on its own control and management energy supply to achieve power balance control, system operation optimization, fault detection and protection and power quality

Control mode and strategy is a core part of a microgrid system. A typical microgrid system includes a distributed power generation system (diesel generator, combined heat power, etc . . . ); renewable energy facility (solar panel, wind turbine), energy storage, and power consumption (EV charger . . . ). A microgrid controller normally acts as the management and control system in for the microgrid system. The microgrid controller communicates with all the microgrid components and sends data to the upper level management system (such as an energy management system (EMS), or other decision system), and transmits control commands to the microgrid components to make sure all the components work normally. For some systems, the microgrid controller also has the function of making decisions, which means the microgrid controller has overlapping functions with an EMS.

Therefore, there is provided a novel system and method for microgrid control.

### SUMMARY OF THE DISCLOSURE

The disclosure is directed at a method and system for microgrid control. In one embodiment, the disclosure is directed at a microgrid analysis and control platform. In one embodiment, the disclosure integrates an onsite power management system with a cloud-based remote monitoring system, a remote operation interface and an energy-finance analyst system. Normally the onsite power management system includes a battery energy storage system (BESS), a monitoring system, an energy management system and sometimes, a remote monitoring system. The system and method of the disclosure is flexible for different kinds of projects including but not limited to solar plus BESS, diesel plus BESS, and the like.

In one embodiment, the disclosure is directed at a cloud-based microgrid analyst, or analysis, and control platform integrating a microgrid controller, a software module executing remote monitoring software and a software module executing microgrid operation software. The disclosure may also include a separate energy data analyst software to analyze the project finance benefit of the project. In another embodiment, a microgrid controller platform remote monitoring and operation component is capable of interacting different components, including but not limited to BESS+solar, on-grid, off-grid, etc. In a further embodiment, the disclosure may include a computer readable medium which includes computer readable code that, when executed, performs microgrid control.

In one aspect of the disclosure, there is provided a microgrid controller for use with a microgrid system including a microgrid on-site control component; a microgrid monitoring system component; and a microgrid operation system component.

In another aspect, the controller further includes a microgrid energy analysis component. In yet another aspect, the microgrid on-site control component is integrated with project site components. In a further aspect, the project site components include at least one of a battery management system, a power conversion system, a HVAC system, a fire suppression system, a solar power generator, a wind power generator and a diesel generator.

In another aspect, the microgrid controller communicates with at least one of a remote monitoring system and an energy management system.

In another aspect of the disclosure, there is provided a method of microgrid control including receiving load data associated with a load requirement for a load at a project site; receiving power data associated with power production capacity of components at the project site; determining how to supply power to the load via the components at the project site; and transmitting signals to the components to supply power to the load based on the determination.

In yet another aspect, receiving load data includes receiving a load profile. In a further aspect, performing an energy finance analysis of the components at the project site.

### BRIEF DESCRIPTION OF THE DRAWINGS

Embodiments of the present disclosure will now be described, by way of example only, with reference to the attached Figures.

FIG. 1 is a schematic diagram of a microgrid controller;

FIG. 2 is a schematic diagram of the microgrid controller in its operational environment;

FIG. 3 a schematic diagram of a microgrid controller communication protocol and IP address component;

FIG. 4 is a schematic diagram of a microgrid controller structure for use in an off-grid mode;

FIG. 5 is a load profile curve applied in examples of the disclosure;

FIG. 6 is a chart showing an input/output power curve of different components in off grid application;

FIG. 7 is a flowchart of a method of microgrid controller operation for off-grid mode control logic;

FIG. 8 is an input/output power curve of different components in a diesel augmentation application;

FIG. 9 is a flowchart of a method of microgrid controller operation for diesel augmentation mode control logic;

FIG. 10 is a flowchart of a method of microgrid controller operation for EMS communication function;

FIG. 11 is an input/output power curve for a capacity expansion application;

FIG. 12 is a flowchart of a method of microgrid controller operation for capacity expansion control logic;

FIG. 13 is a flowchart of a method of energy-finance analysis for a microgrid controller;

FIG. 14 is an input/output power curve of different components for the system with best payback;

FIG. 15 is an input/output power curve of different components for the system with client optimized initial investment;

FIG. 16 is a schematic diagram of a Cloud based monitoring interface;

FIG. 17 is a schematic diagram of a User interface of modular microgrid controller;

FIG. 18 is a schematic diagram of a remote monitoring system structure;

FIG. 19 is a schematic diagram of a configuration for a microgrid controller system;

FIG. 20 is a state transition diagram for a microcontroller system;

FIG. 21 is a schematic screenshot of a microcontroller analysis system interface;

FIG. 22 is a schematic screenshot of an energy cost input page interface;

FIG. 23 is a schematic screenshot of a battery parameter setting interface;

FIG. 24 is a schematic screenshot of a solar panel parameter setting interface;

FIG. 25 is a schematic screenshot of a result page interface; and

FIG. 26 is a schematic screenshot of a result curve interface.

### DETAILED DESCRIPTION OF THE PREFERRED EMBODIMENTS

In the following, various example systems and methods will be described herein to provide example embodiment(s). It will be understood that no embodiment described below is intended to limit the disclosure. The claims are not limited to systems, apparatuses or methods having all of the features of any one embodiment or to features common to multiple or all of the embodiments described herein. A claim may include features taken from any embodiment as would be understood by one of skill in the art. The applicants, inventors or owners reserve all rights that they may have in anything disclosed herein, for example the right to claim such an invention in a continuing or divisional application and do not intend to abandon, disclaim or dedicate to the public any such invention by its disclosure in this document.

The disclosure is directed at a method and system for microgrid control. In one embodiment, the system may include a microgrid controller, or platform, that may be integrated with an on-site, or project site, controller, a cloud-based monitoring system, a multi-component energy system operation software, and an energy-finance analysis system.

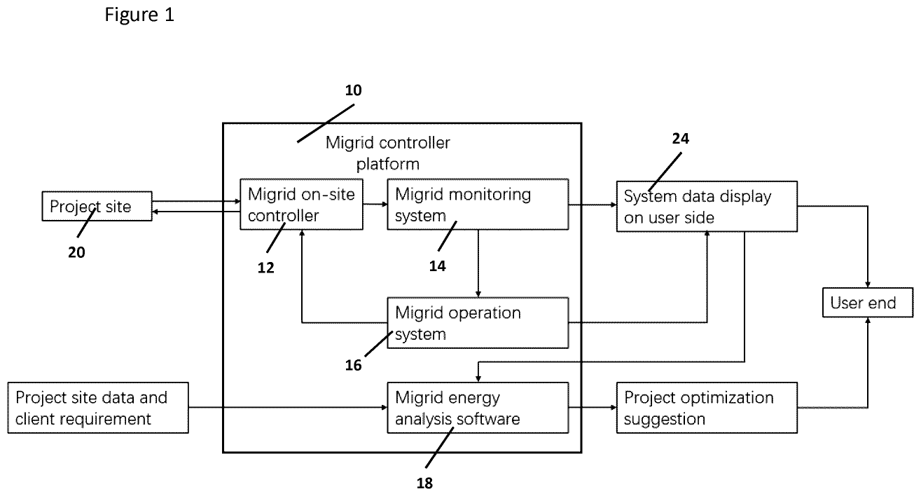

Turning to FIG. 1, a schematic diagram of aspects of a microgrid system is shown. In the current embodiment, the system 100 includes a microgrid, or Migrid, controller, or platform, 10, that includes a Migrid on-site controller 12, a Migrid monitoring system 14, a Migrid operation system 16, and a Migrid energy, analyzer, or analysis software 18. As can be seen in FIG. 1, the Migrid on-site controller 12, the Migrid monitoring system 14, and the Migrid operation system 16 are in communication with each to calculate or determine a control strategy, or an optimized control strategy, for a project site 20. In the current embodiment, the on-site controller 12 communicates with and controls apparatus at the project site 20. The Migrid monitoring system 14 processes and passes the data collected from and/or by the Migrid on-site controller 12 and displays the data to the users (such as via a system data system 24) or uploads the data to a remote monitoring system as discussed below. The Migrid operation system 16 is the operational component where the users can set up the control logic, limitation and/or timing. The Migrid energy analysis software 18 is an offline system that functions to analyze project data to obtain or determine a project setup according to the client requirement and a financial result. The determined project setup may include a proper system size and operation method according to the client criteria.

The microgrid controller could be customized according to the project components, application environments and client requirement. In one embodiment, the controller may include a Migrid platform, a Migrid monitoring system and a Migrid controller system. In a further embodiment, the controller may also include a Migrid energy analysis software. The components of the controller work together to monitor the system to safeguard the microgrid system and project components. In another embodiment, the controller controls the system would improve or maximize efficiency over a whole project lifetime.

For example, before the microgrid project, or system, is delivered, or during the design stage of the microgrid system, an engineer may design the size of each component of the Microgrid system such as a solar component, a battery component, and/or a diesel component by executing, or applying, the Migrid energy analysis software 18 according to a client's budget and other conditions of the project site. After determining a project setup, the project setup may be installed at the project site.

After the microgrid system is installed, the Migrid operation system 16 and Migrid on-site controller 12 may operate, in real-time, to control the components to the determined operation conditions to ensure safety, and to provide a microgrid system that has an improved energy cost saving. The operating or operation conditions may include, at least one of, but not limited to, solar output, load demand and/or battery state-of-charge (SOC). At the same time, the Migrid monitoring system 14 may collect the system data from the components and send this data to end users. In addition, the data could also be sent to the engineers, and the engineers would be able to use the Migrid energy analysis software 18 to optimize, or improve, the microgrid system size with the data collected form the real-time data collection, and provide suggestions to update the system to improve system efficiency and other benefits to the project.

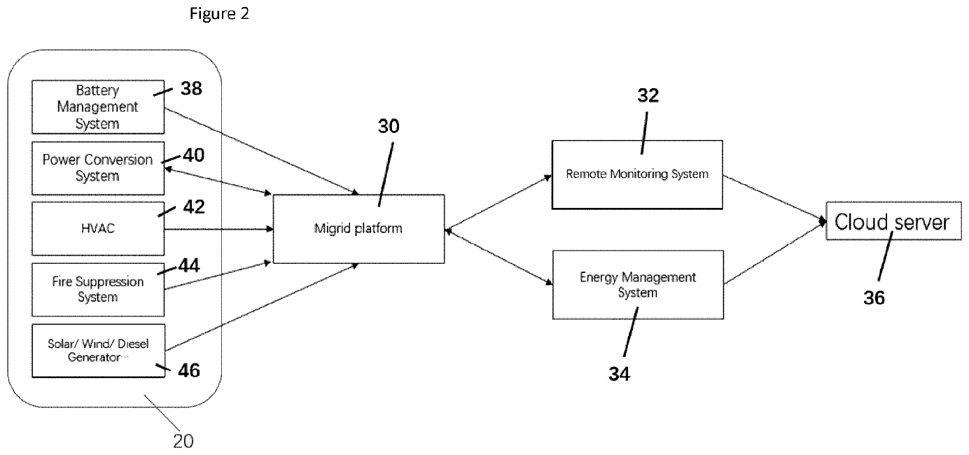

As can be seen in FIG. 2, which is another schematic diagram of a microgrid system, in the current embodiment, the Migrid controller or platform 30 may control different components of the project site 20. In the current embodiment, these components include a battery management system (BMS) 38, which is the main management system of battery that may function to ensure the safety of the battery; a power conversion system (PCS) 40 that functions as the converter between AC and DC, and acts as the main operation component for the charging and discharging of the battery; and a HVAC 42 which may be seen as the environmental management system of the battery enclosure. The project site 20 may further include a fire suppression system 44 that may be an optional system to release a fire-extinguishing agent in case of fire and at least one power generator, such as a solar, wind, or diesel generator 46 that may also be seen as an optional part to produce the energy on project site. The function of the Migrid platform 30 is to receive and manage the data from the components of the project site and perform preliminary control by transmitting control signals to the components according to the preset control logic, such as pre-determined by the users or an energy management system (EMS) 34. Flowcharts outlining different methods of operation of the microgrid controller are discussed below with respect to different modes and some, or all, of the project components.

In addition, the Migrid platform 30 may also collect and process the data from the project site components listed above and upload it to the cloud server 36 through a remote monitoring system (RMS) 32. Some examples of the functions of the microgrid controller and/or the components at the project site are described below. It should be noted that the Migrid controller or platform may perform other functionalities. For example, other functions of the Migrid platform, or controller, 30 may include data storage, system protection, and state of charge (SOC) management with respect to the battery. The Migrid platform may also collect and store the data of the battery energy storage system (BESS), and perform the system protection according to the data and pre-set values.

System protection may be performed by having users setup protection, threshold and/or warning values through the microgrid system whereby if data received from one of the components passes the threshold or warning value, an alarm may be generated. In one embodiment, the Migrid system may process the data collected from the upper control and monitoring systems and compare them with the protection or warning values. When the data received by the microgrid controller exceeds a threshold value, the microgrid controller performs or executes protection activity according to the pre-set rules and may send warning signals to users.

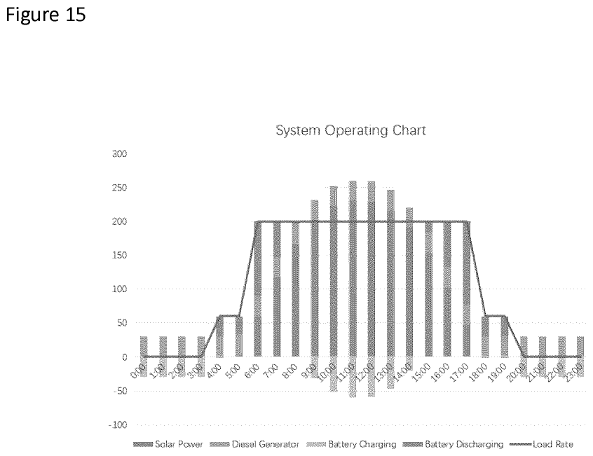

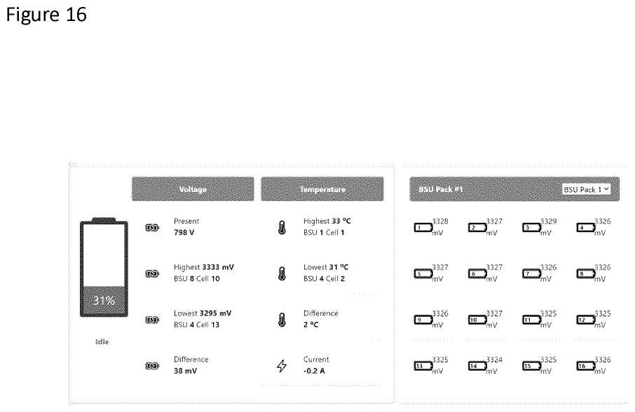

In another example, the Migrid platform may monitor over/low voltage conditions to provide charging/discharging power control to the project components according to the pre-set, or pre-determined values. In addition, the Migrid platform may also monitor the cell balancing status for rechargeable batteries if this component is installed for the project site, as shown in FIG. 15. Users can choose the Dual-equilibrium module (a method which combines the active and passive equilibrium to keep the battery cells voltage better balanced) to the microgrid controller. That module would monitor the voltage of all the battery cell of the system and perform the judgement algorithm in real time. The Dual-equilibrium (such as one disclosed in PCT Application No. PCT/CA2020/050651 filed May 14, 2020, which is hereby incorporated by reference) module would send users messages according to the analysis results, mainly about the battery cell voltage information and whether the system needs active equilibrium. This function is one function of the Migrid platform. As shown in FIG. 16, the Migrid cloud-based monitoring system could read the BESS and other subsystem data and indicate this to the users.

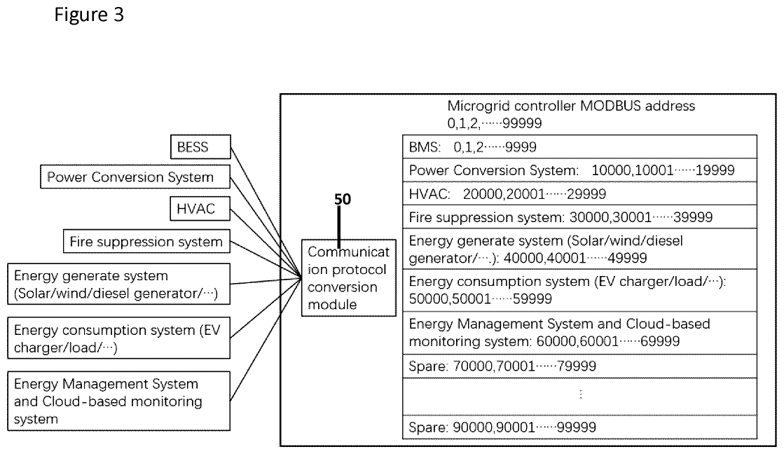

In operation, communication between the different components at the project site and the Migrid controller or platform may be a problem as the different components execute different communication protocols according to the function of the components. For example, most BMS and PCS use Modbus TCP, or CANBUS to communicate. Most HVAC use RS 485 port based on Modbus RTU and for fire suppression system, I/O is mostly used as the communication protocol. As shown in FIG. 3, in the current embodiment, the migrid controller or platform may further include an internal communication protocol converter 50 to solve the problem by enabling the migrid controller to communicate with the different components. The converter 50 converts I/O or CANBUS communication protocol signals to Modbus TCP communication protocol signals, as it is easier to communicate through Modbus TCP to other external components such as, but not limited to, the remote monitoring system and the EMS. The Migrid platform may reserve Modbus communication address or addresses for different systems as the address is customizable according to client requirement. In addition, the Migrid platform is also able to reserve some spare addresses for the further updating of the on-site project such as if new components are added. For example, if there is a need to install a new component at the project site after the initial project site is set up, for instance if the client wants to add an off-gas system to detect the gas release before the thermal runaway of a BESS, the added off-gas system could use one of the spare address in the converter 50 to communicate with the BESS and ensure the safety of the system.

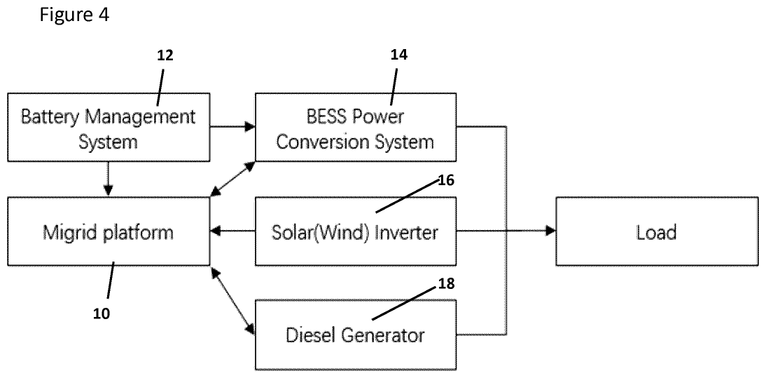

The high flexibility of the Migrid platform allows it to have some control functions for microgrid systems that include different sub-systems and for different purposes. FIG. 4 relates to the application of the Migrid platform in an off-grid microgrid system with BESS, solar panels (wind turbine), and diesel generator. In the current embodiment, under the off-grid mode, the Migrid platform 10 performs, or operates, as the main controller of the off-grid system. In this off-grid system, the battery management system 12 is the control system for the battery to ensure the battery safety. BESS power conversion system 14 is a DC and AC converter, that acts as the main operator for battery charge and discharge. Solar or wind apparatus 16 is a renewable power source to serve as the load or to charge the battery and diesel generator 18 acts as a backup for the load in case the renewable power or energy source is unavailable, and the battery is empty. All of the components listed above would communicate with Migrid platform 10 to send the operation status and data to the microgrid Platform 10, and to receive the control signal or signals from the Migrid Platform 10 to work properly to make sure the load is always powered. The Migrid platform may monitor the BESS SOC and the solar (wind) power apparatus status during daily running, or operational, situations. On the load side, the load would be supported by BESS, solar (wind), and/or the diesel generator according to the SOC and/or solar (wind) status.

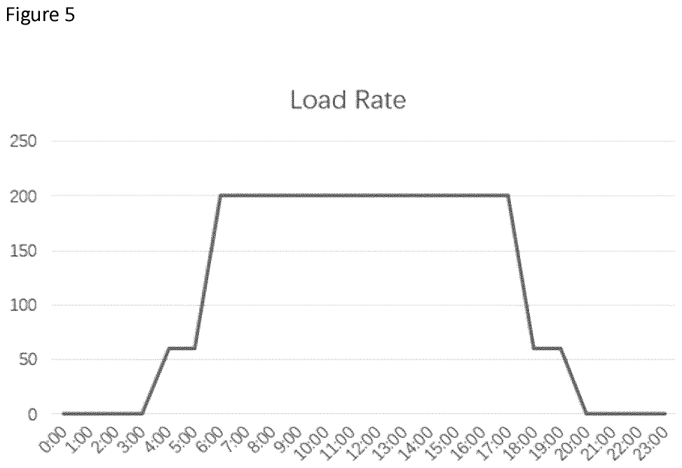

An example of a load profile is shown in FIG. 5. The load profile shows that from 20:00 to 3:00, the load usage, or requirement, is 0, and at 3:00 the load usage or requirement begins to increase, and the load increase up to 200 kW from 6:00 to 18:00.

For this example, it is assumed that the system is connected with a microgrid system including a 150 kW/660 kWh BESS and a 330 kW solar (wind) power source system. In the current embodiment the Migrid platform is monitoring the load, solar production, and the status of BESS in real-time. The Migrid platform, or controller, compares load demand and power produced by solar power generation apparatus in real-time to control the flow direction of the energy. In the daytime, such as from 8:00 to 15:00 as shown in FIG. 4, when the solar (wind) power source is able to cover the load demand, the load would be supported by the solar (wind) power apparatus.

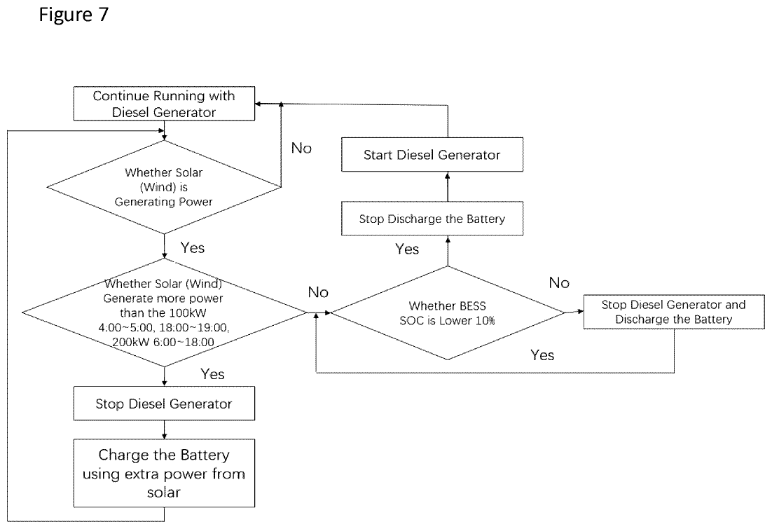

As shown in the flow chart in FIG. 7, initially, a check is performed to determine if the solar power generating apparatus is generating power (700). If so, a check is performed to determine if the power being generated by the solar power generating apparatus is more than a predetermined value (such as 100 kW) (702). If so, the diesel generator may be stopped (704), assuming that it is operational. In the case where the solar (wind) apparatus generates more power than the load demand, the spare power from the solar (wind) apparatus may be used to charge the BESS (706).

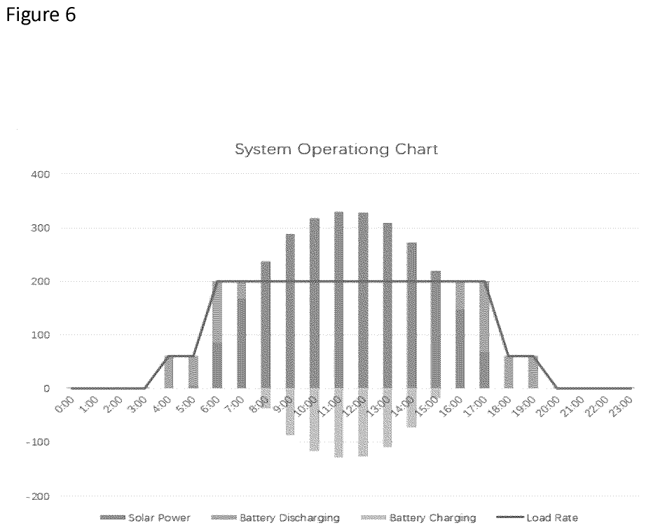

However, if the power generated by the solar power apparatus is lower than the load usage or requirement (such as in FIG. 6 between 4:00-7:00 and 16:00-20:00), as shown in FIG. 7, the system would determine if the SOC of the BESS is lower than 10% (708), in other words, determines if the BESS has enough energy to support the load. If the BESS has enough power, the load is supported by BESS along with the solar power generation apparatus (710). If BESS SOC is lower than 10%, the battery is discharged (712) and the diesel generator started (714) or, in other words, the diesel generator will kick in to support the load along with the solar power generation, or source, apparatus (716). In one embodiment, the control logic is managed by the Migrid, or microgrid, controller according to the flowchart shown in FIG. 7. Due to the modular design of the Migrid platform, this application is also scalable by selecting a further module when required.

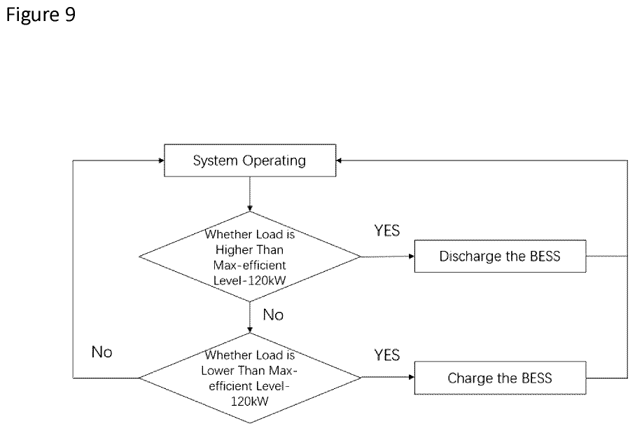

FIG. 9 shows the application of the Migrid platform in a diesel generator and BESS microgrid system or application. In this system or example, the function of the BESS may be for diesel augmentation. A characteristic of general diesel generators is that the fuel efficiency could reach a higher level under certain output power. As such, the microgrid controller may control the charge/discharge of BESS to maintain the diesel generator at a higher efficiency to improve the diesel efficiency. In this application, the system monitors the load profile applied as discussed above, along with monitoring the diesel generator load or load requirement.

Initially, when the system is operational (900), a check is performed to determine if the load is higher than a max-efficient level (such as 120 kW) (902). If so, the BESS may be discharged (904). If not, a further check is performed to determine is the load is lower than the max-efficient level (906). If so, the BESS is charged (908).

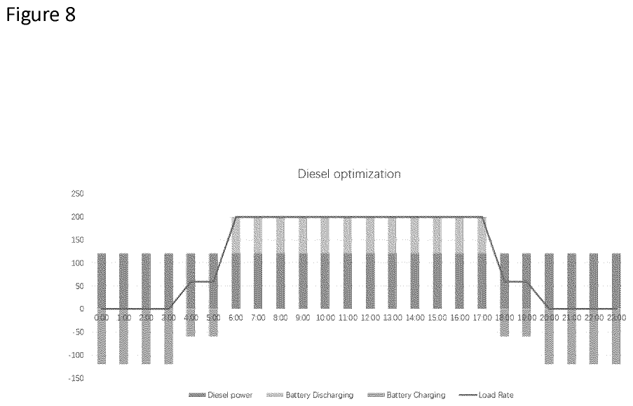

In other words, if the load is higher than an average level, the microgrid controller would transmits signals to discharge the BESS to support the diesel generator; and if the load is lower than the average level, the controller may transmit signals to charge the BESS to keep the diesel generator at a load with a higher diesel efficiency. Using the example load profile, as shown in FIG. 8, it is assumed that a high, or maximum, efficient output power for the diesel generator is 120 kW. From 18:00 to 6:00, the diesel generator charges the BESS with the extra power along with supplying the load, and from 6:00 to 18:00, the diesel generator still outputs 120 kW power to maintain a high or maximum fuel efficiency while the load is supported by the diesel generator and the BESS.

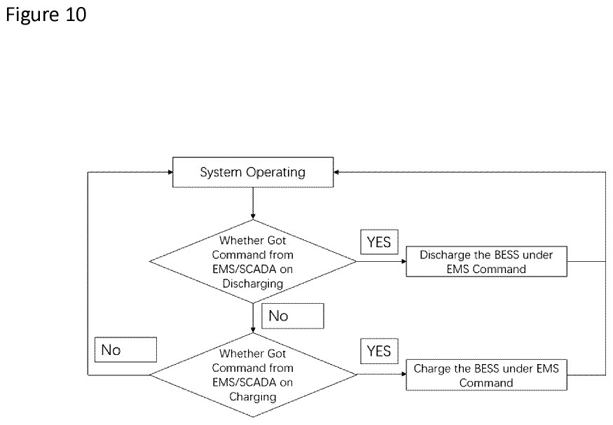

FIG. 10 is a flowchart showing the utilization of the Migrid controller or platform in an on-grid application with an EMS. This application usually utilizes the BESS to perform a peak demand response, global adjustment, and/or peak shaving. In this application, the EMS performs peak demand prediction, and communicates with the Migrid platform. The function of Migrid Platform in this application is to process the control instruction or instructions from the Energy Management System provided by the client or project owner.

As shown in FIG. 10, if the Migrid platform receives a discharging command from the EMS (1000), the Migrid platform would process the command signal and control the BMS and PCS to discharge by transmitting signals to the components (1002). When the Migrid platform receives a charging command from the EMS (1004), it will process and control the BESS and PCS to charge (1006). As mentioned above, the Migrid platform may also monitor the status the BESS to send alarm or warnings to the client, when necessary.

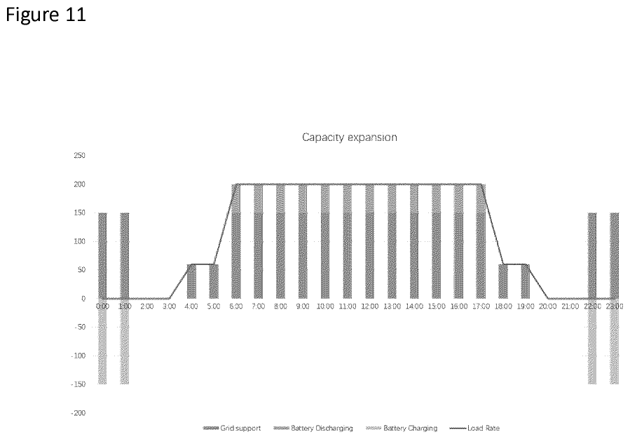

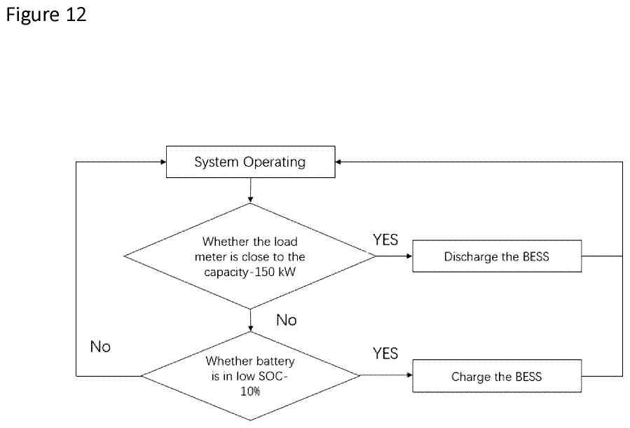

It should be noted that the applications of the system and method of the disclosure is not limited to these applications. For example, as shown in FIG. 12, the microgrid controller, or platform, may be applied in a capacity expansion project, to control the charge/discharge of BESS according to load and BESS SOC. Using the load profiles as schematically shown in FIG. 11, assuming the grid capacity is limited to 150 kW maximum, when the load requirement is 200 kW from 6:00 to 18:00, the Migrid system may control the BESS to discharge and support the grid as schematically shown in FIG. 12. Initially, while the system is operating (1200), a check is performed to determine if the load meter is close to a capacity threshold (1202). If so, the BESS is discharged (1204). If not, a check is performed to determine if the batter is at a low SOC (1206). If so, the BESS is charged (1208).

As further shown in FIG. 11, the Migrid platform would also monitor the status of the BESS whereby when the BESS SOC is lower than 10% and the load is lower than 150 kW, the BESS would be charged.

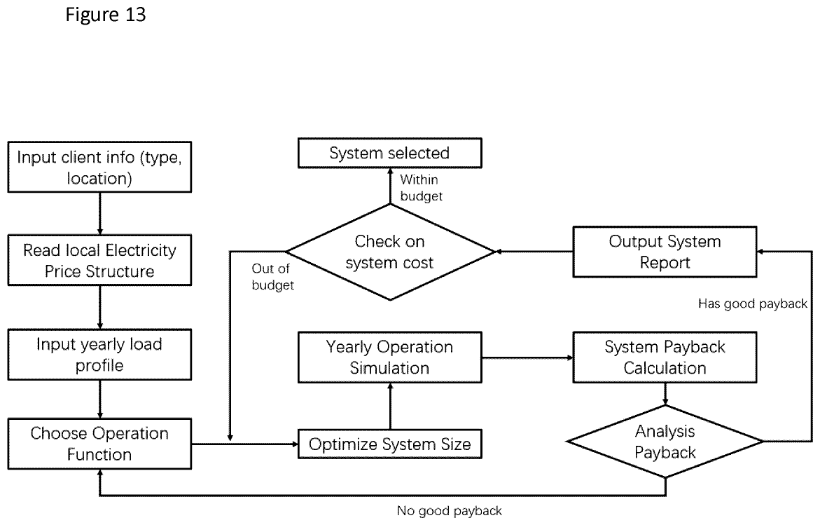

FIG. 13 is a flowchart showing one embodiment of a method that may be performed by the microgrid energy analyses module. In one embodiment, the analysis module is used to perform a finance analysis to determine components that are required for a project or system based on user criteria, such as, but not limited to, load size, power generation capacity, size of project location. The system may then communicate the project plan to the user. The project plan may also include a budget according to the result of the analysis.

In one embodiment, the client information (application type, location . . . ), local electricity price, and yearly profile would be used to optimize or determine the system size or components for the project plan. The optimization result may be applied to perform the yearly operation simulation automatically and check the payback. If the payback is as expected, the system size would be determined according to the client's budget. If the payback is not within expected, the system would update the operation function and keep doing the optimization.

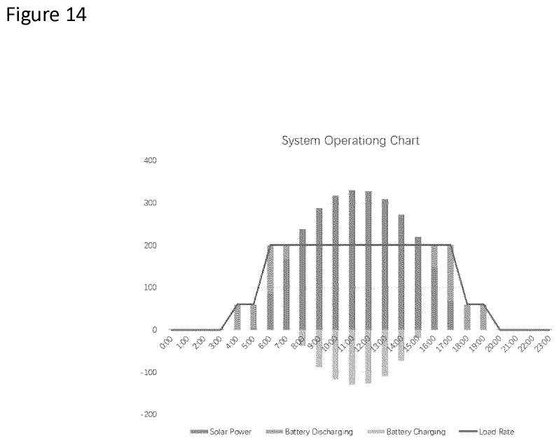

For example, using the profile of FIG. 14, according to the load profile, electricity rate ($0.5/kWh), system cost ($500/kWh for BESS and 2000/kW Solar), the analysis module may determine that a microgrid system with a 600 kWh BESS and 330 kW solar power generation apparatus could achieve the best payback, which is assumed to be 5 years. The total cost would assumed to be $960,000. The output/input power of different components of the designed system is shown as FIG. 14 where the load would be supported by BESS and solar power generation systems. When solar output power is not enough to cover the load demand, such as from 4 am to 8 am, and from 4 pm to 7 pm, the battery may be discharged to support the load. If with this solution, the client is concerned about that the initial cost being too high, the analysis module may recalculate the microgrid system size according to the client's expected investment and payback years. For example, the client may wish to reduce the initial investment to around $720,000. Therefore, the analysis module may update the size of components in the project according to the updated $720,000 budget. The platform can come up with plenty of different Solar+BESS+diesel generator combinations with a budget upper limitation of $720,000 and from which the client is free to choose according to the site condition. For example, the system may be customized to 150 kW/550 kWh BESS and a 230 kW solar power generation apparatus. If this size is not enough to cover the load, a 30 kW diesel generator may be added where the output power of different components may be as shown in FIG. 15. In this case, the total cost would be $710,000, and payback year would assumed to be 5.3 Years.

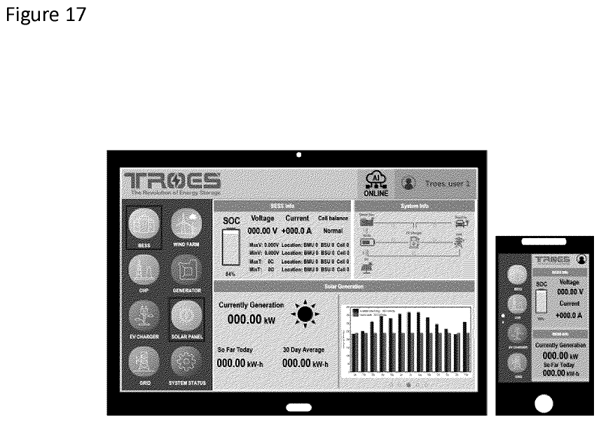

FIG. 17 shows a user interface of the Migrid operation system. The shown interface could be displayed by the onsite monitoring system (HMI, on-site computer), and displayed by the remote monitoring computer. It should be noted that the content in the User Interface are not limited as shown in the FIG. 17 and the modules may be customized according to the project.

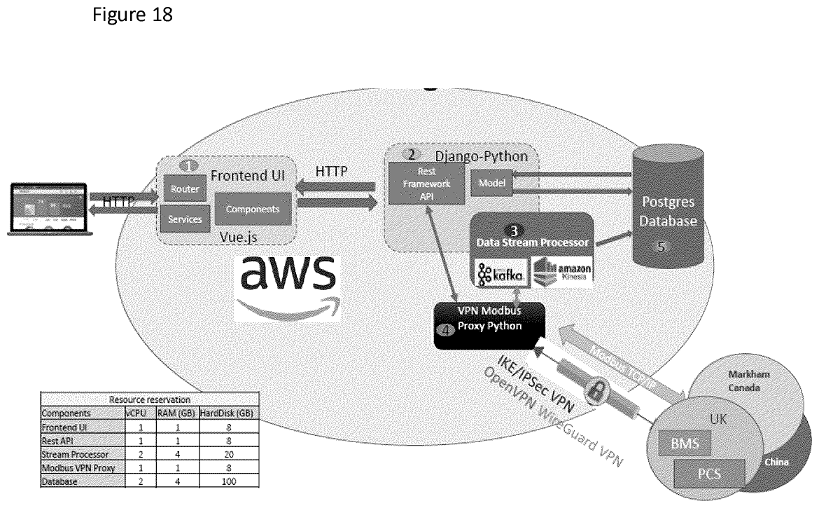

FIG. 18 is a schematic diagram of a structure of the remote monitoring part of the Migrid, or microgrid, controller. The system contains a frontend UI, Python based frame work API, Data processor, an Onsite router, and database. The current embodiment uses AWS to store and process the data.

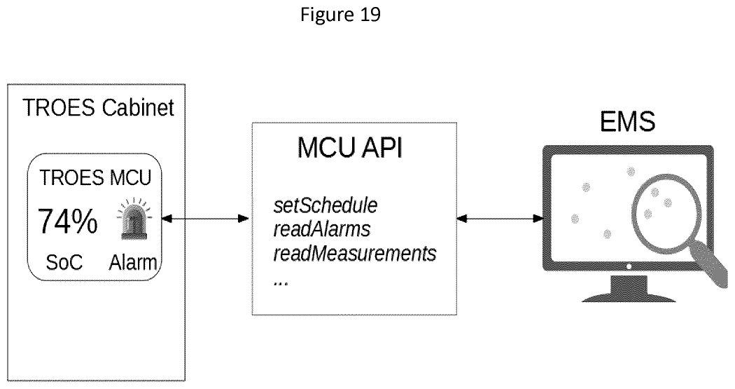

As shown in FIG. 19, the microgrid controller may be housed within a cabinet, alongside the current embodiment battery energy storage system (BESS) as depicted in FIG. 19. Since the cabinet has a heating, ventilation, and air-conditioning (HVAC) unit, the microgrid controller hardware may experience the advantage of superior air quality and added protection from harsh temperatures.

The Migrid microgrid controller may also be seen as a control system that manages the operation of the BESS and provides an application programming interface (API) that enables a system operator, or higher level EMS, to generate or set setpoints, control schedules, or read aggregated data measurements remotely. The microgrid controller can also communicate and control a set of pre-selected, or project, devices, such as a power conversion system (PCS), as well as a diesel generator, for the purposes of providing adequate power in off-grid scenarios. Thus, the microgrid controller can operate in different, such as three (3) control modes, which can be toggled by an authorized system operator.

These control modes include manual where setpoints for active and reactive power on all controllable devices are set; scheduled where setpoints for active power and reactive power based on time of day are set; and automated where a control algorithm operates controllable devices automatically.

A high-level block diagram of the microgrid controller can be seen in FIG. 19, where the microgrid controller will be deployed on a touch-screen interface, which will reside in the cabinet, where the BESS is also housed. A higher level EMS, or system operator, can issue remote commands to the microgrid controller via the API as explained above.

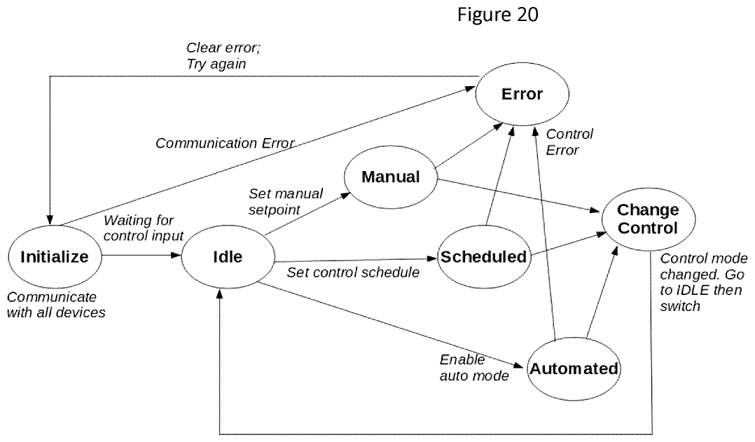

An example state transition diagram for the Microgrid controller can be seen in FIG. 20, while a description of the individual states can be found below.

Initialize: microgrid controller loads a configuration file that identifies the network addresses of all controllable and/or measurable devices. If devices can be communicated with, the MCU moves to the Idle state. If communication errors are present, the Microgrid controller goes to the error state, attempts to clear the error, and returns to the Initialize state to try again.

Idle: microgrid controller is idle and not actively controlling any devices. Power transfer to/from devices is 0.

Manual: microgrid controller has received a manual setpoint, which is executed on a controllable device.

Scheduled: microgrid controller is in scheduled mode and sets setpoints based on a control schedule loaded into its memory.

Automated: microgrid controller is operating in automated mode, which fulfills power adequacy in off-grid environments.

Change Control: Manages the transitions between control modes. Each switch of control mode requires power transfer to/from devices to be stopped. Thus, the microgrid controller will move to the Idle state, then return to the intended control mode (Manual, Scheduled, Automated).

Error: Handles any communication, control, or configuration errors. Any persistent, severe errors will raise an alarm and reduce power transfer to/from devices to 0.

For the hardware part, PLC based and non-PLC based platforms are contemplated. For PLC systems, control software is generally developed using ladder-logic or structured-text programming languages, however, non-PCL based platforms are preferred.

Non-PLC hardware platforms, such as single board computers, microcontrollers, or standard computers, can be programmed in a variety of programming languages that can handle complex mathematics and datasets, such as LabVIEW, Java, Python, or C++. These platforms can also be ruggedized to withstand harsher operating conditions. They also provide modularity, flexibility, and ability to handle complex software requirements

In terms of software, different options such as Matlab, and some other open source softwares are contemplated, however, in the current embodiment, Labview is used as the core frame of the software. Another programming language to develop the microgrid controller may be Python.

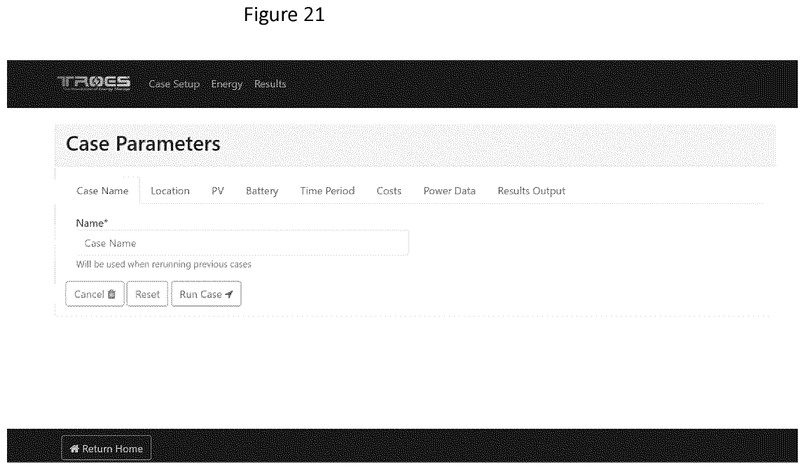

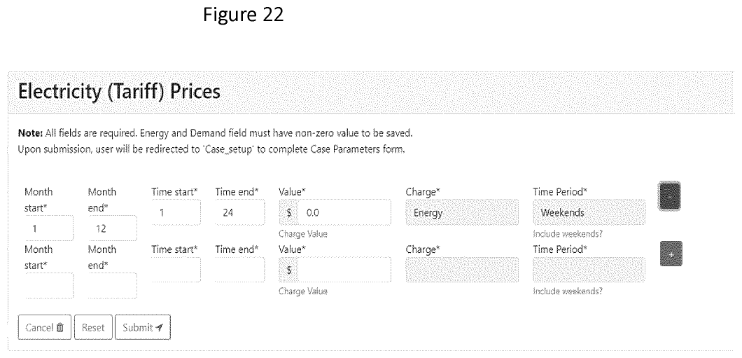

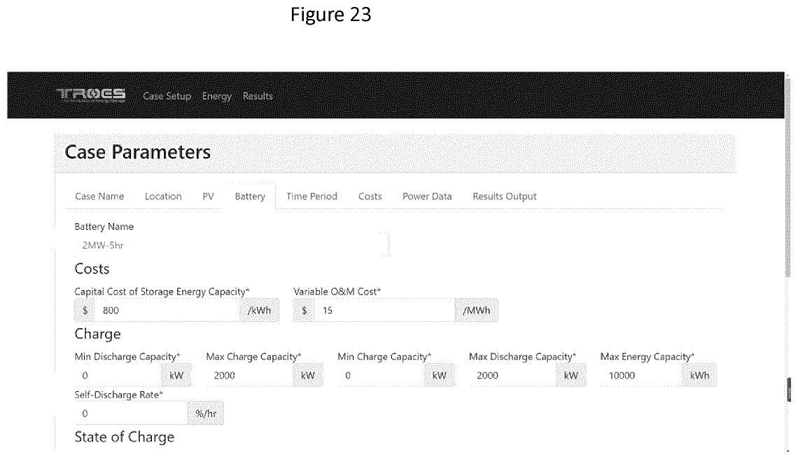

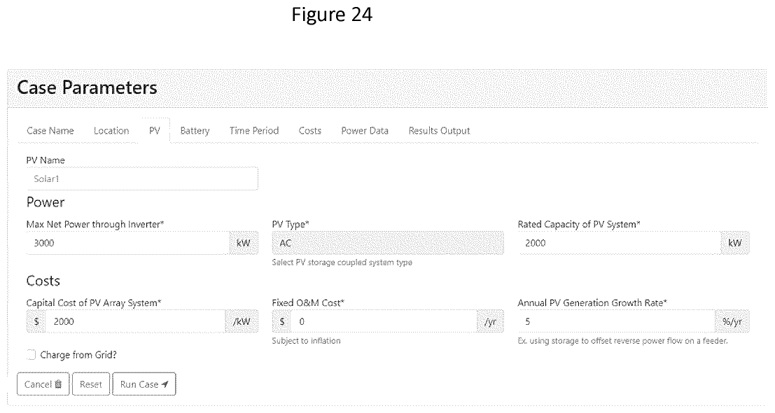

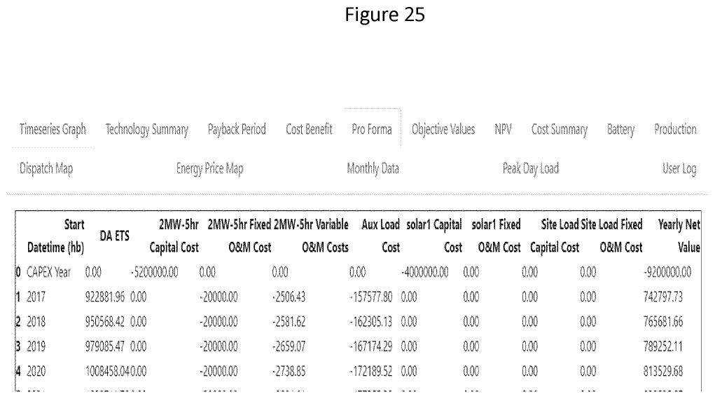

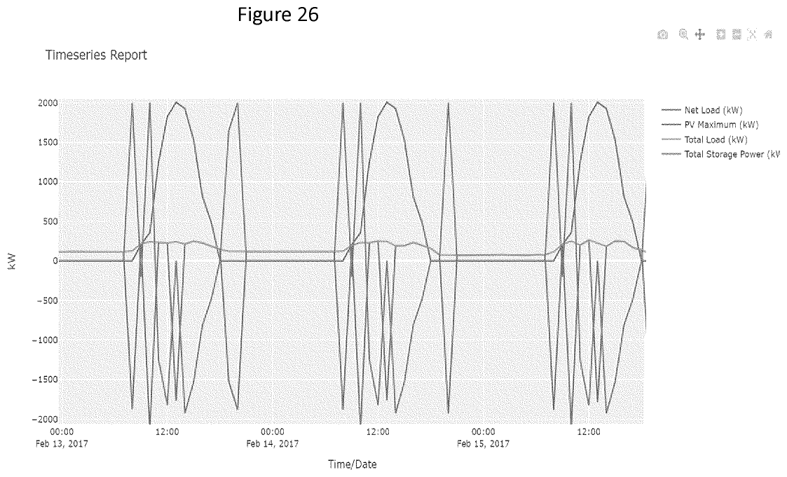

For the microgrid energy-finance analyst module, FIG. 21 shows a schematic of a main interface of the Migrid energy analysis tool. The analysis follows the process of ‘Determine the location (For solar condition)—PV sizing and cost—Battery sizing and cost—local energy data’. FIG. 22, FIG. 23 and FIG. 24 show the interface of the input of solar, battery and local energy cost respectively. FIG. 25 and FIG. 26 show the result of the simulation in forms of data and curve respectively.

In another embodiment, the microgrid controller may function as a higher-level management system for a BESS system. It could collect and process the signal from all the components in a BESS system, including battery, Power conversion system, HVAC, fire suppression system, EMS/SCADA, and cellular communication data for remote monitoring.

In a further embodiment, the microgrid controller may function in an Off grid application whereby in this mode the micro-grid controller could be the management system for an integrated microgrid system including a solar panel, wind turbine, BESS and diesel generator.

In another embodiment, the microgrid controller may function in On-grid application whereby, in this mode, the microgrid controller has modular grid connection. It may communication with upper level Energy Management System (EMS) or grid control system to manage the microgrid system. Furthermore, in this mode the microgrid control system could achieve the function of demand support, peak shaving, capacity expansion, and UPS function.

In another embodiment, the Migrid controller platform could perform the logic control for microgrid systems with different components, including but not limited to solar+BESS, Diesel+BESS, etc.

The microgrid controller may also perform energy finance analysis to calculate the payback year, and the economic benefit of the project according to the project location, local electricity price and the project budget.

What is claimed is:

1. A microgrid controller for use with a microgrid system comprising:
a microgrid on-site control component;
a microgrid monitoring system component; and
a microgrid operation system component.

2. The microgrid controller of claim 1 further comprising:
a microgrid energy analysis component.

3. The microgrid controller of claim 1 wherein the microgrid on-site control component is integrated with project site components.

4. The microgrid controller of claim 3 wherein the project site components comprise at least one of a battery management system, a power conversion system, a HVAC system, a fire suppression system, a solar power generator, a wind power generator and a diesel generator.

5. The microgrid controller of claim 1 wherein the microgrid controller communicates with at least one of a remote monitoring system and an energy management system.

6. A method of microgrid control comprising:
receiving load data associated with a load requirement for a load at a project site;
receiving power data associated with power production capacity of components at the project site;
determining how to supply power to the load via the components at the project site; and
transmitting signals to the components to supply power to the load based on the determination.

7. A method of claim 6 wherein receiving load data comprises:
receiving a load profile.

8. The method of claim 6 further comprising:
performing an energy finance analysis of the components at the project site.
